(19) United States
(12) Patent Application Publication
(10) Pub. No.: US 2005/0107150 A1
(43) Pub. Date: May 19, 2005

(54) Wagering game

(76) Inventor: Ernest W. Moody, Las Vegas, NV (US)

Correspondence Address: JOHN EDWARD ROETHEL, 2290 S. JONES BLVD. #100, LAS VEGAS, NV, 89146, US

(21) Appl. No.: 10/989,670

(22) Filed: Nov. 15, 2004

Related U.S. Application Data
(60) Provisional application No. 60/523,455, filed on Nov. 19, 2003.

(51) Int. Cl. A63F 13/00

(52) U.S. Cl. 463/16; 463/25

(57) ABSTRACT

Two or more indicia are displayed to the player. The value of the indicia are hidden from the player and are randomly selected from a group of values. The values are directly related to the amount wagered by the player. Once the player has completed making his wager, one or more of the indicia are activated randomly and the values of the activated indicia are revealed to the player. The player receives an award based on the values of the indicia revealed to the player.

### CROSS-REFERENCE TO RELATED APPLICATION

This application is based on and claims the benefit of Provisional Application Ser. No. 60/523,455, filed Nov. 19, 2003, entitled “Wagering Game.” This invention relates primarily to a wagering game that can be played as an electronic video game or as a table game, and more particularly to a wagering game in which the player makes a wager and two or more indicia are displayed to the player. The value of the indicia are determined by the amount of the player's wager.

### BACKGROUND OF THE INVENTION

There are many different types of casino wagering games of chance. Many games are live table games that use one or more decks of playing cards or one or more dice to effect the random outcome of the game.

Other games of chance are based on the actual or simulated spinning of slot machine reels which can be mechanical or electronic gaming machines. Other gaming machines display hands of stud or draw poker, or hands of Twenty-One or one or more number games such as keno or bingo.

There have been few live or electronic games of chance that merely display the results of random events in a direct format in which an award is simply made to the player after a wager has been made. Often the player is required to make a selection of an occurrence (such as picking a number as in roulette) and then a random selection is made (such as spinning the roulette wheel and allowing a ball to fall into a space). If the player has made the proper selection, then the player receives an award.

There is a need in the casino gaming business for a simple, straightforward game that allows the player to make a wager and then have the results of a random occurrence displayed to the player. While slot machines display the results after the player has made a wager, the results of the slot machine are predetermined symbols that do not change regardless of the amount wagered by the player.

It is submitted that an attractive casino game of chance would effect a change in the possible winning symbols depending on the amount wagered by the player. Whenever the player increases his wager, the pool of possible winning amounts would then be increased to allow the player to achieve higher awards on account of the player's willingness to wager higher amounts.

It is an object of the present invention to provide a wagering game in which the amount potentially won by the player is based on the amount of the player's wager.

It is a feature of the present invention to provide a plurality of hidden indicia to the player. The player makes a wager to be eligible to participate in the play of the game. Depending on the amount of the player's wager, the hidden indicia are designated with payout amounts—the higher the amount wagered by the player, the greater the payout amounts associated with the hidden indicia. After the player has completed his wager, one or more of the hidden indicia are revealed to show whatever winning payout amounts the player has achieved, if any.

It is an advantage of the present invention that the potential award to the player is based on the amount of the player's wager. This encourages a player to wager higher amounts in hopes of receiving a greater return.

Other objects, features and advantages of the present invention will become apparent from a consideration of the following detailed description.

### SUMMARY OF THE INVENTION

The method of the present invention involves the player making a wager to play a wagering game. Two or more indicia are displayed to the player. The value of the indicia are hidden from the player and are randomly selected from a group of values. The values are directly related to the amount wagered by the player.

Once the player has completed making his wager, one or more of the indicia are activated randomly and the values of the activated indicia are revealed to the player. The player receives an award based on the values of the indicia revealed to the player.

### BRIEF DESCRIPTION OF THE DRAWINGS

FIG. 1 shows the gaming machine configured to practice the method of present invention.

FIG. 2 shows the gaming machine configured to practice the method of present invention including a first representative outcome of a round of play that could occur during the play of the game.

FIG. 3 shows the gaming machine configured to practice the method of present invention including a second representative wager for a round of play that could occur during the play of the game.

FIG. 4 shows the gaming machine configured to practice the method of present invention including a second representative outcome of a round of play that could occur during the play of the game.

FIG. 5 shows the gaming machine configured to practice the method of present invention including a second representative wager for a round of play that could occur during the play of the game.

FIG. 6 shows the gaming machine configured to practice the method of present invention including a second representative outcome of a round of play that could occur during the play of the game.

### DETAILED DESCRIPTION OF THE PREFERRED EMBODIMENTS

The present invention is preferably displayed on an electronic video gaming and is designed to be played by having the game results displayed on a video screen. Alternatively, the present invention can also be played as a live table game with a dealer displaying the game results to one or more players seated around a gaming table.

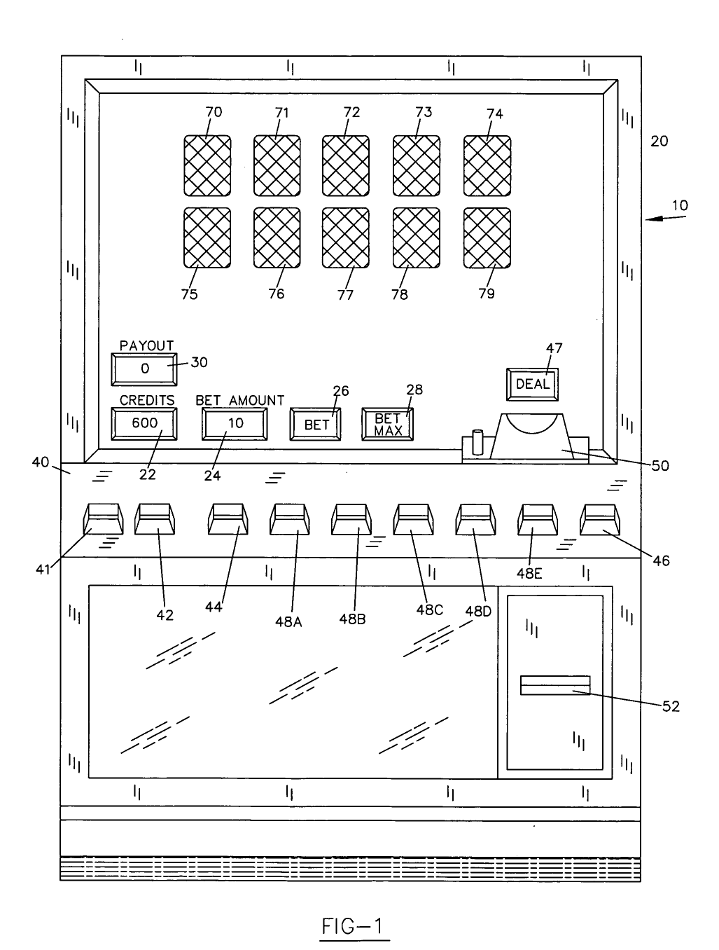

FIG. 1 shows a gaming machine upon which the method of the present invention can be carried out. The gaming machine 10 includes a video screen display 20 on which is shown the indicia 70-79 that will be used during the play of the method of the present invention. The video screen display 20 also includes other information and data presented to the player to allow the player to understand the play of the game and to effect the operation of the method.

In the preferred embodiment of the present invention, the video screen display 20 shows a credit meter 22 and a display of the “AMOUNT BET” 24 which is the number of credits wagered for a particular round of play of the game. The video screen display also includes a payout meter 30 which shows the amount won by the player during a particular round of play of the game. The video screen display also has a DEAL touch screen location 47 to allow the player to cause the initial display of the hidden indicia which occurs after the player has completed making his wager.

Other touch screen locations allow the player to make his initial wager, which can be made one credit at a time using the BET location 26 or which can be made by wagering the maximum number of credits allowed by the gaming machine using the BET MAX location 28.

The gaming machine 10 also has a button panel 40 which includes typical buttons that the player may press to activate various actions during the play of the method of the present invention. A CASH OUT button 41 is provided to allow the player to collect any credits which the player has accrued on the credit meter 22. A BET MAX button 42 and a BET button 44 are provided to allow the player to wager either the maximum amount of credits or to wager one credit at a time on the play of the game as desired by the player, if the player wishes to use buttons to place his wager instead of using the touch screen locations 26 and 28 to place his wager. A DEAL button 46 is provided to allow the player to effect the display of the hidden indicia after the wager has been made should the player prefer to use the button panel instead of the DEAL screen location 47 on the video screen display 20.

The gaming machine 10 also includes a coin head 50 to allow the player to insert coins or gaming tokens as wagers to allow play of the gaming machine 10. A bill acceptor slot 52 is also provided on the gaming machine 10. In order to accrue credits that may be used to play the gaming machine 10, the player inserts paper currency or other suitable script or gaming coupons into the bill acceptor slot 52 behind which, on the interior of the gaming machine, is mounted a bill acceptor which takes in and validates the currency. The monetary value of the inserted currency is then applied to the credit meter 22, the credits on which the player may use to play the gaming machine.

A plurality of buttons 48A-48E can also be provided on the button panel 40 to allow the player to select the amount of the wager that the player wishes to make if the player chooses to use pre-designated increments for wagering. For example, TEN CREDIT button 48A allows the player to select to wager ten credits on a round of play. TWENTY CREDIT button 48B allows the player to select to wager twenty credits on a round of play. THIRTY CREDIT button 48C allows the player to select to wager thirty credits on a round of play. FORTY CREDIT button 48D allows the player to select to wager forty credits on a round of play. FIFTY CREDIT button 48E allows the player to select to wager fifty credits on a round of play.

Any suitable distribution of pre-designated wagering amounts may be allocated to the buttons and fewer or more than five buttons 48 can be used.

Instead of using buttons on the button panel, the video screen display 20 can be provided with touch screen locations (not shown) that the player would touch to select the pre-designated amounts of a wager that the player wishes to make.

Any other conventional and suitable equipment can be included in the gaming machine.

The preferred embodiment of the present invention uses ten indicia 70-79, although any suitable number may be used. Prior to the activation of the game, the indicia 70-79 are displayed in any suitable hidden manner, such as face down on the screen display 20.

Behind or on the back side of the hidden indicia 70-79 are the amounts that may be potentially won by the player as well as indicators of a losing selection. These amounts are selected randomly by the computer controls of the gaming machine prior to any of the indicia being revealed during the play of each round of the game.

As shown in FIG. 1, a round of play of the game begins with the player making a wager to activate the game.

For example, as shown in FIG. 1, the player may wager ten credits on a round of play which can be effected by pressing the TEN CREDIT wager button 48A. Based on the amount of the wager, the computer controls of the gaming machine randomly select payout amounts to be displayed when the hidden indicia are revealed. The payout amounts selected are based on the amount of the player's wager with higher wagers being associated with higher payout amounts.

After the player has made his wager and after the computer controls have selected the payout amounts, the DEAL touch screen location 47 is illuminated and/or the DEAL button 46 is illuminated to indicate to the player that he should touch the DEAL location 47 or DEAL button 46 to reveal the hidden indicia.

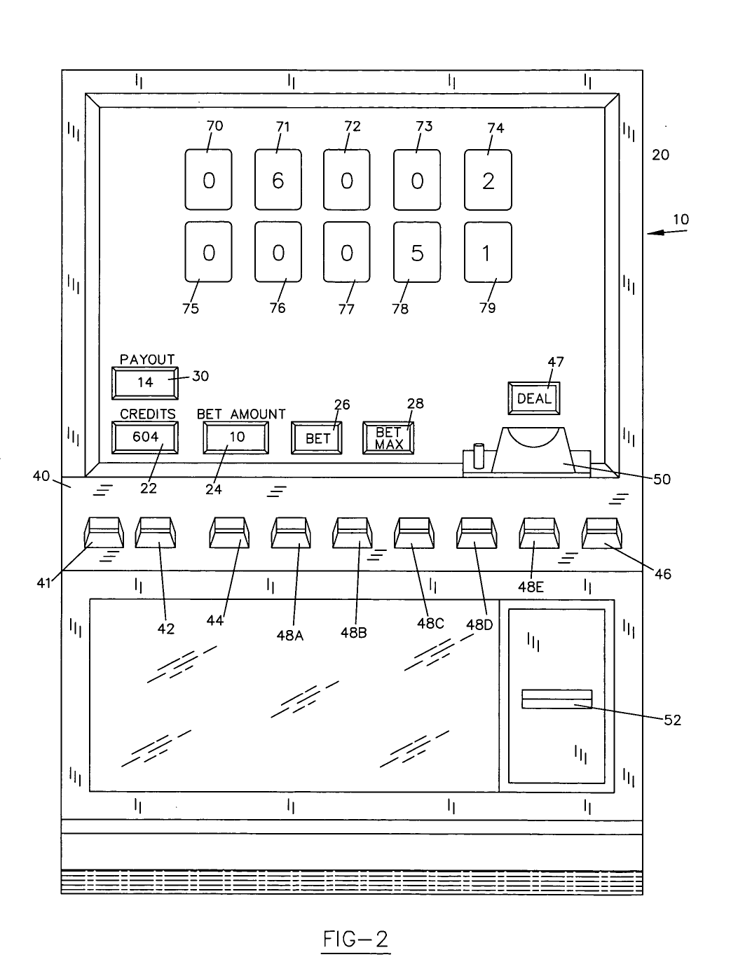

FIG. 2 shows the results of the play of the round of the game. The hidden indicia 70-79 have been revealed and the player has achieved a total of fourteen credits. The ten hidden indicia show some of the payouts as zero, which are losing plays, and the other payouts total fourteen credits. The payout amount of fourteen credits is shown in the payout meter 30.

Any suitable range of payouts may be used. For example, when the player wagers ten credits, the payout can range from zero up to ten credits. If the player were to achieve a ten credit payout in each of the ten indicia 70-79, the player's maximum award would be one hundred credits, which is a good payout for a ten credit wager.

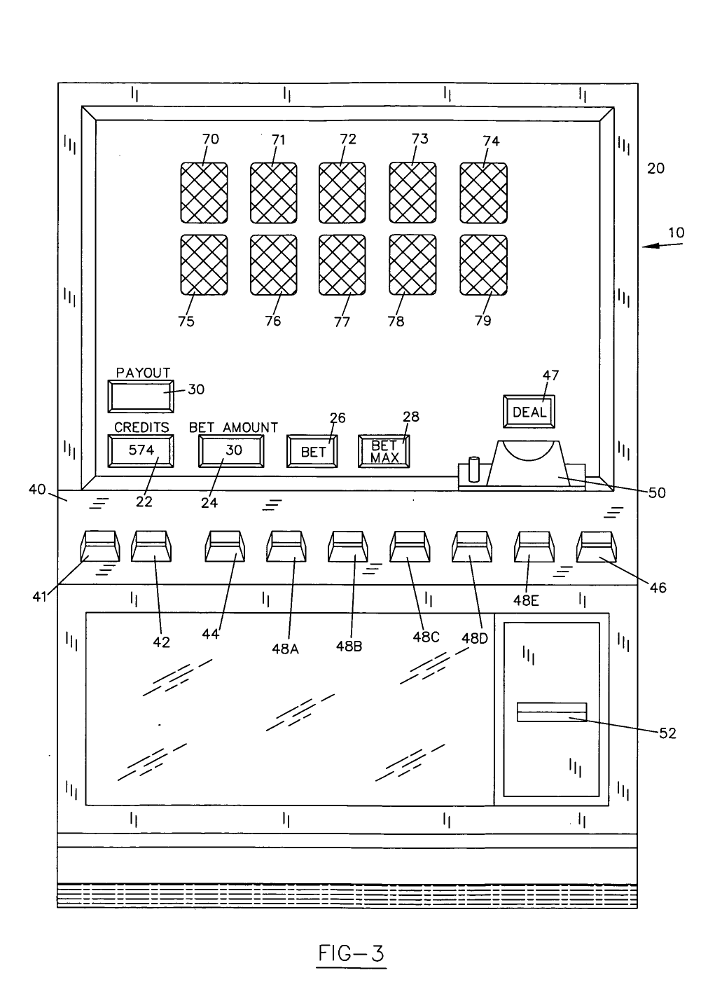

FIG. 3 shows an example of another round of play of the game. The player makes a wager of thirty credits, which can be effected by pressing the THIRTY CREDIT wager button 48C. Based on the amount of the wager, the computer controls of the gaming machine randomly select payout amounts to be displayed when the hidden indicia are revealed.

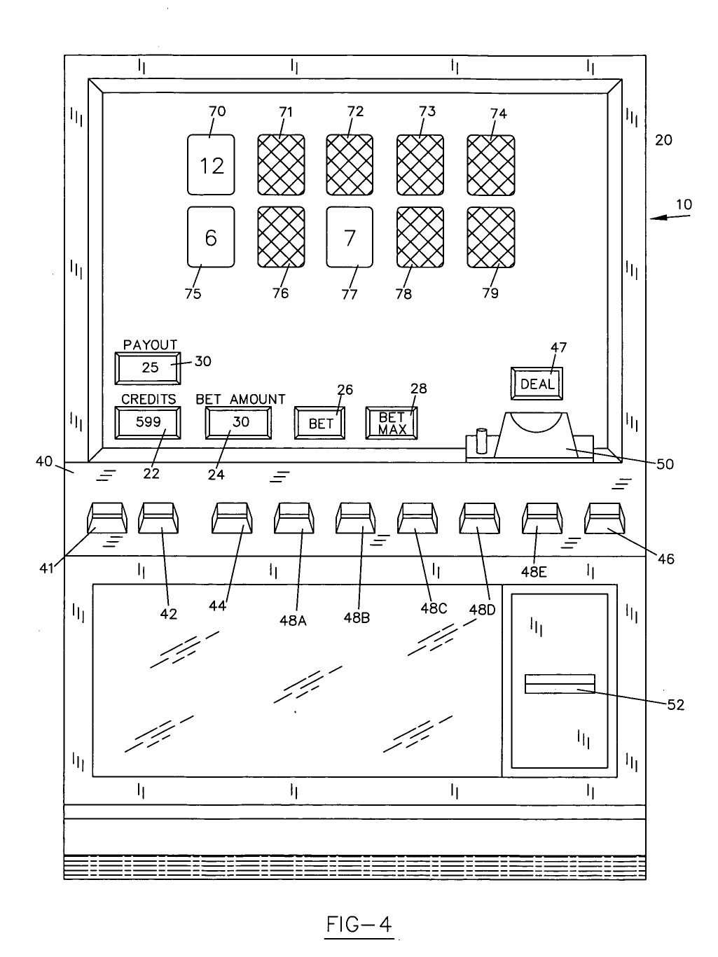

FIG. 4 shows the results of the play of the round of the game. The some of the hidden indicia 70-79 have been revealed and the player has achieved a total of twenty-five credits. In the preferred embodiment of the present invention, all of the hidden indicia are revealed to the player with none, some or all of the hidden indicia showing winning payout amounts and the other indicia showing zero payout amounts. Alternatively, as shown in FIG. 4, only one or more of the hidden indicia may be revealed with the other hidden indicia remaining face down or hidden. The effect of keeping some of the indicia hidden is the same as showing an indicia with a zero payout amount.

The payout amount of twenty-five credits is shown in the payout meter 30.

Again, any suitable range of payouts may be used. For example, when the player wagers thirty credits, the payout can range from zero up to twenty credits. If the player were to achieve a twenty credit payout in each of the ten indicia 70-79, the player's maximum award would be two hundred credits.

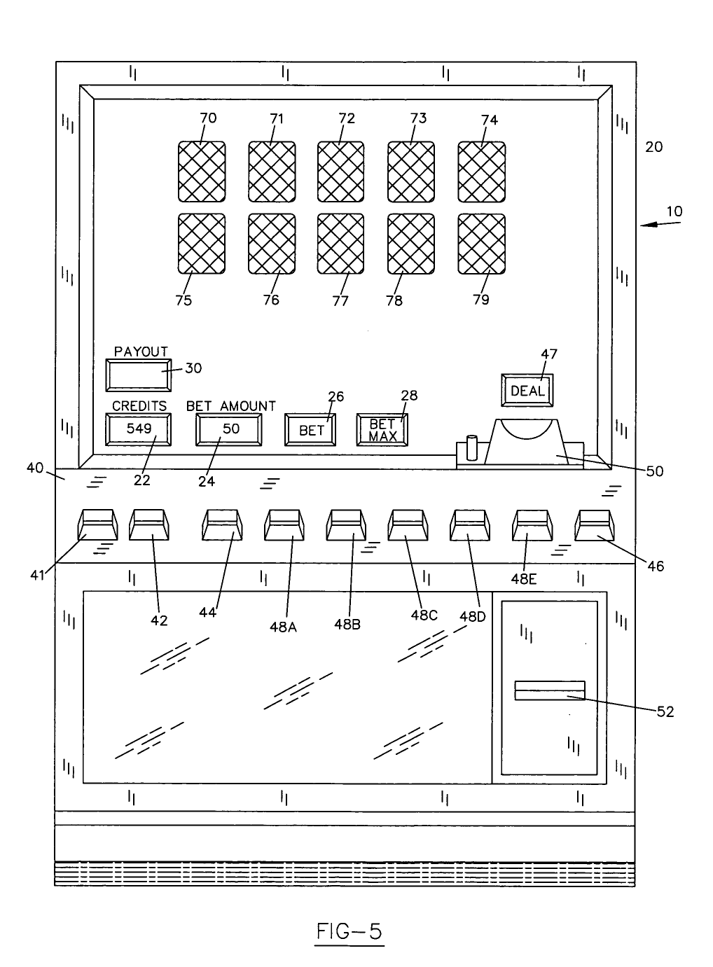

FIG. 5 shows an example of yet another round of play of the game. The player makes a wager of fifty credits, which can be effected by pressing the FIFTY CREDIT wager button 48E. Based on the amount of the wager, the computer controls of the gaming machine randomly select payout amounts to be displayed when the hidden indicia are revealed.

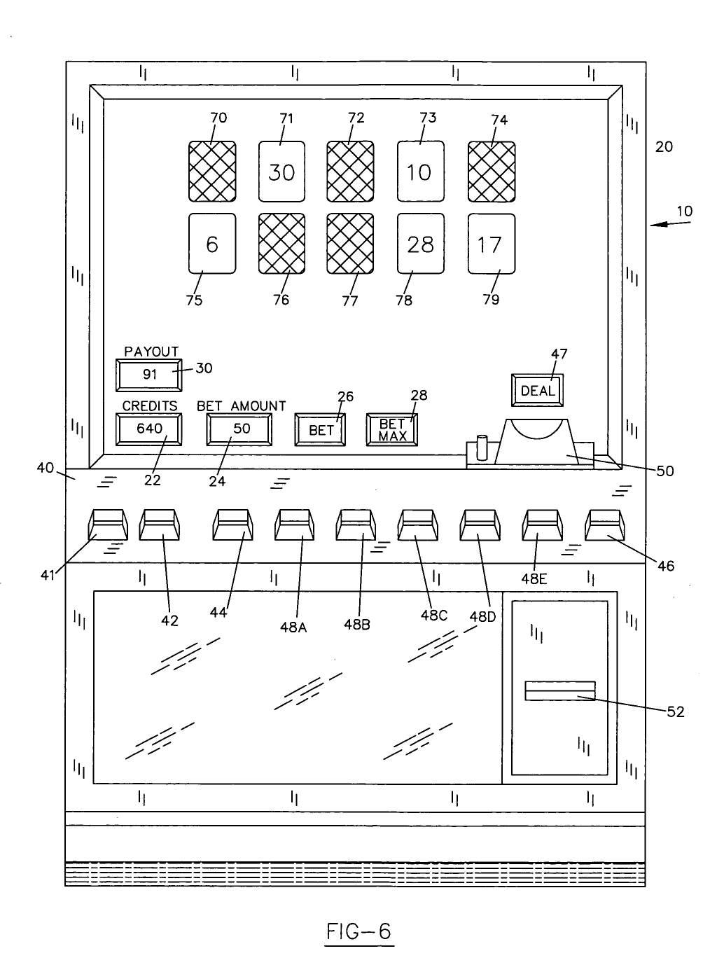

FIG. 6 shows the results of the play of the round of the game. The some of the hidden indicia 70-79 have been revealed and the player has achieved a total of ninety-one credits. The payout amount of ninety-one credits is shown in the payout meter 30.

Again, any suitable range of payouts may be used. For example, when the player wagers fifty credits, the payout can range from zero up to thirty credits. If the player were to achieve a thirty credit payout in each of the ten indicia 70-79, the player's maximum award would be three hundred credits.

The amount possible to be won by the player is dependent on the amount wagered by the player. As the player increases the number of credits wagered, the possible payouts which may be achieved are increased. In effect, the pool of possible payouts amounts increases as the player makes higher wagers.

Any suitable display of the indicia may be used. For example, the indicia could be a collection of rockets all facing upward. If a particular rocket has a winning amount associated therewith, suitable animation could be provided such as the rocket blasting off with the winning amount left behind as a number superimposed over the flame and smoke exhaust of the rocket.

While the invention has been illustrated with respect to several specific embodiments thereof, these embodiments should be considered as illustrative rather than limiting. Various modifications and additions may be made and will be apparent to those skilled in the art.

1. A wagering game method comprising:
a) displaying a plurality of hidden indicia to a player;
b) the player making a wager to be eligible to participate in the wagering game;
c) designating each of the hidden indicia with a payout amount, each payout amount being dependent on an amount of the wager made by the player; and
d) revealing one or more of the hidden indicia to display one or more payout amounts won by the player, if any.

2. The wagering game method of claim 1 in which each of the payout amounts designated on the hidden indicia increase as the amount of the wager made by the player increases.

3. The wagering game of claim 1 in which the hidden indicia are initially selected randomly from a pool of hidden indicia.
